(19) United States
(12) Patent Application Publication
(10) Pub. No.: US 2026/0024282 A1
(43) Pub. Date: Jan. 22, 2026

(54) EXPERT-BASED GENERATION AND REFINEMENT OF TRAINING- AND ENTERTAINMENT STORIES

(71) Applicant: SAP SE, Walldorf (DE)

(72) Inventors: Frank FEINBUBE, Potsdam (DE); Oliver SCHIRMER, Heidelberg (DE); Lars RAUSCH, Hohennauen (DE)

(21) Appl. No.: 18/773,927

(22) Filed: Jul. 16, 2024

(51) Int. Cl. G06T 19/00; G06N 3/09

(52) U.S. Cl. CPC G06T 19/00; G06N 3/09; G06T 2200/24; G06T 2219/024

(57) ABSTRACT

A system associated with an immersive experience framework may include an immersive virtual scenario data store containing information about a plurality of three-dimensional scenarios (each associated with a series of scenario chapters). An immersive virtual scenario tool may receive, from a user, an immersive virtual scenario user description (e.g., including a location description). A request prompt is created based on the scenario user description and transmitted to an agent manager AI model. The agent manager AI model facilitates iterative interactions between the agent manager AI model and a plurality of autonomous agent expert AI models to automatically create a series of scenario chapters based on the immersive virtual scenario user description. The system may then store information about the series of scenario chapters in the immersive virtual scenario data store and the user can interact with the scenario using a substantially real-time experience interaction engine.

### BACKGROUND

An enterprise may want to create an immersive virtual story or scenario (e.g., using a three-dimensional interactive environment) for a number of reasons. For example, a business might want to create an immersive virtual scenario to train or evaluate employees. Manually creating such an immersive virtual scenario, however, can be a time consuming and expensive task, especially when there are a substantial number of locations, characters, and use cases (e.g., various objects and characters may need to be generated and located within the environment, story lines and scripts may need to be generated, etc.). Moreover, existing methods for creating these environments may not be sufficiently immersive to facilitate effective learning and recall or to provide a realistic context for training or simulation. In addition, there is a need for a system that allows for the automated and repeatable creation of these environments (tailored according to the specific requirements of the scenario and user at hand). Existing solutions may be overly generic, not customizable, or inefficient in terms of the time and resources required for creation. Moreover, the development, implementation, and maintenance of high-quality, immersive virtual entertainment environments can be expensive and resource intensive. There is a need for a more cost-effective solution that still delivers high-quality results.

It would therefore be desirable to provide an immersive virtual scenario tool within an immersive experience framework in a secure, automatic, and efficient manner.

### SUMMARY

According to some embodiments, methods and systems associated with an immersive experience framework may include an immersive virtual scenario data store that contains information about a plurality of three-dimensional scenarios (each associated with a series of scenario chapters). An immersive virtual scenario tool may receive, from a user, an immersive virtual scenario user description (e.g., including a location description). A request prompt is created based on the scenario user description and transmitted to an agent manager AI model. The agent manager AI model facilitates iterative interactions between the agent manager AI model and a plurality of autonomous agent expert AI models to automatically create a series of scenario chapters based on the immersive virtual scenario user description. The system may then store information about the series of scenario chapters in the immersive virtual scenario data store and the user can interact with the scenario using a substantially real-time experience interaction engine.

Some embodiments comprise: means for receiving, by a computer processor from a user, an immersive virtual scenario user description; means for creating a scenario prompt based on the immersive virtual scenario user description; means for transmitting the scenario prompt to an agent manager AI model; means for selecting a plurality of agent expert AI models from a library of potential expert AI models; means for facilitating iterative interactions between the agent manager AI model and the plurality of autonomous agent expert AI models to automatically create a series of scenario chapters based on the immersive virtual scenario user description; means for storing information about the series of scenario chapters in an immersive virtual scenario data store; and means for arranging for the user to interact with the three-dimensional scenario using a substantially real-time experience interaction engine.

Some technical advantages of some embodiments disclosed herein are improved systems and methods to provide an immersive virtual scenario tool within an immersive experience framework in a secure, automatic, and efficient manner.

### BRIEF DESCRIPTION OF THE DRAWINGS

FIG. 1 is a high-level immersive experience framework architecture in accordance with some embodiments.

FIG. 2 is a method according to some embodiments.

FIG. 3 is an overall workflow in accordance with some embodiments.

FIG. 4 is an immersive environment in accordance with some embodiments.

FIG. 5 shows three-dimensional scenario chapters according to some embodiments.

FIG. 6 shows revisions to original three-dimensional scenario chapters in accordance with some embodiments.

FIG. 7 illustrates some examples of use cases according to some embodiments.

FIG. 8 is a training scenario workflow in accordance with some embodiments.

FIG. 9 is an entertainment scenario workflow according to some embodiments.

FIG. 10 is an example of how a set of agent experts might be constructed in accordance with some embodiments.

FIG. 11 illustrates a tablet computer providing a user expert selection display according to some embodiments.

FIG. 12 is a scenario workflow incorporating feedback in accordance with some embodiments.

FIG. 13 is an example of agent expert weights according to some embodiments.

FIG. 14 is an apparatus or platform according to some embodiments.

FIG. 15 is a portion of an immersive virtual scenario database in accordance with some embodiments.

FIG. 16 is an immersive virtual scenario tool operator or administrator display in accordance with some embodiments.

### DETAILED DESCRIPTION

In the following detailed description, numerous specific details are set forth in order to provide a thorough understanding of embodiments. However, it will be understood by those of ordinary skill in the art that the embodiments may be practiced without these specific details. In other instances, well-known methods, procedures, components and circuits have not been described in detail so as not to obscure the embodiments.

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers’ specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

There is a pressing need for a more efficient and effective method of generating stories, such as those associated with training and entertainment use cases, for complex scenarios. Embodiments described herein may facilitate targeted performance improvement and preference-based story creation while reducing the labor and expertise required for the subdivision of these scenarios. The generation of training and entertainment stories for complex scenarios may be addressed, in some embodiments, by leveraging Large Language Models (“LLMs”) and an agent-based system. The system may employ multiple autonomous expert agents, each with varying role specifications, to divide an initial scenario into distinct, manageable chapters that build on one another.

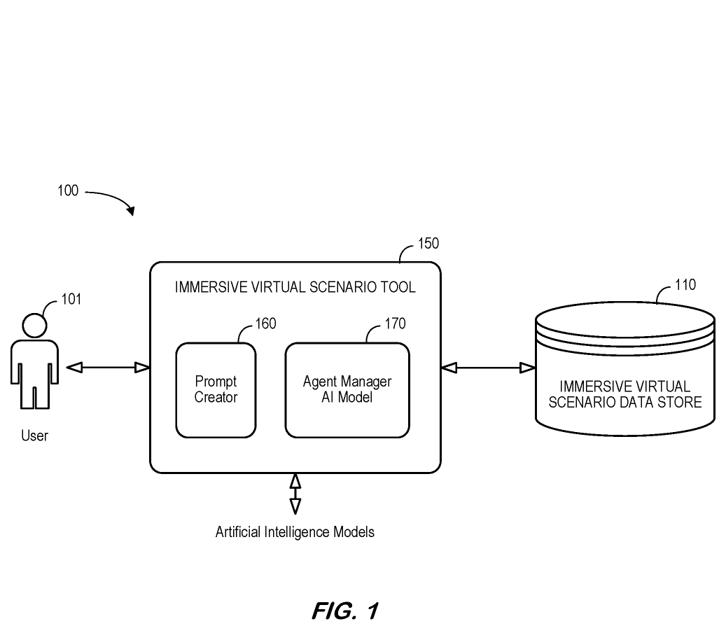

FIG. 1 is a high-level block diagram of one example of an immersive experience framework 100 architecture according to some embodiments. In particular, an immersive virtual scenario tool 150 may access information about a plurality of three-dimensional scenarios (e.g., with three-dimensional scenario having a series of scenario chapters) from an immersive virtual scenario data store 110. The immersive virtual scenario tool 150 may then use a prompt creator 160 and an agent manager AI model 170 to create or modify an immersive experience in response to a request from a user 101. The experience may then be provided to one or more users 101 (e.g., to train or evaluate employees). According to some embodiments, a remote operator or administrator device may be used to configure or otherwise adjust the framework 100.

As used herein, devices, including those associated with the framework 100 and any other device described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The immersive virtual scenario tool 150 may store information into and/or retrieve information from various data stores (e.g., the immersive virtual scenario data store 110), which may be locally stored or reside remote from the immersive virtual scenario tool 150. Although a single immersive virtual scenario tool 150 is shown in FIG. 1, any number of such devices may be included. Moreover, various devices described herein might be combined according to embodiments of the present invention. For example, in some embodiments, the immersive virtual scenario data store 110 and the immersive virtual scenario tool 150 might comprise a single apparatus. The framework 100 functions may be performed by a constellation of networked apparatuses, such as in a distributed processing or cloud-based architecture. In some cases, the immersive virtual scenario tool 150 may process information associated with a number of different enterprises.

The enterprise may access the framework 100 via a remote device (e.g., a Personal Computer (“PC”), tablet, or smartphone) to view information about and/or manage operational information in accordance with any of the embodiments described herein. In some cases, an interactive Graphical User Interface (“GUI”) display may let an operator or administrator define and/or adjust certain parameters via a remote device (e.g., to specify how the tool 150 connects with an enterprise computing environment infrastructure) and/or provide or receive automatically generated recommendations, alerts, summaries, or results associated with the framework 100.

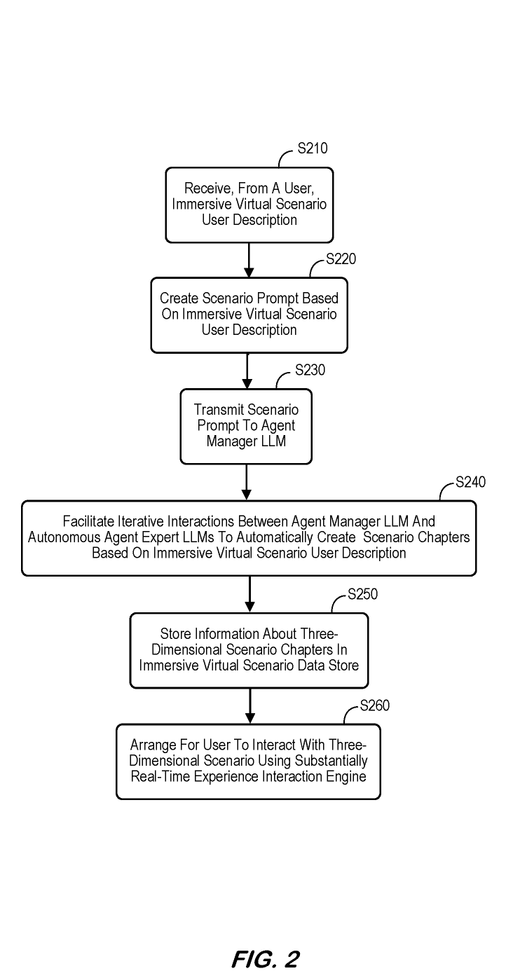

FIG. 2 is a method that might be performed by some or all of the elements of the framework 100 described with respect to FIG. 1. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S210, an immersive virtual scenario user description is received from a user. In some embodiments, the user description includes information about one or more virtual locations. As used herein, the phrase “virtual location” may refer to an interactive, three-dimensional environment that may be experienced by a user (e.g., in connection with a computer display, a virtual reality device, augmented reality glasses, etc.). According to some embodiments, the immersive virtual scenario user description includes information about a room description, a physics description (e.g., how objects should move or interact), a style suggestion (e.g., an office or school environment), a user goal (e.g., making a sale or evaluating a medical condition), a character in the virtual location, etc. The immersive virtual scenario user description received from the user might be associated with, for example, a text request, an audio request (e.g., a spoken description of a location), an image request (e.g., a location that looks similar to this picture), a video request (e.g., the character should move in this fashion), etc.

Although an immersive virtual scenario can be associated with a virtual location or virtual characters, note that embodiments are not limited to these situations. For example, embodiments may be associated with generation of a story that incorporates multiple, varying situations without any specific locations or characters. For example, creation of a basic learning scenario might include reading materials and multiple-choice tests. Moreover, virtual locations might be two-dimensional or three-dimensional. In the case of three-dimensional environments, specific interactions might be included as tasks in a chapter (e.g., in a medical training scenario measuring a patient’s heart with a heart monitor might be included as a task). Interactions could also be realized in a two-dimensional environment with typical “comic-like” action bubbles which trigger the interaction.

At S220, the system may automatically create a scenario prompt. The scenario prompt might be based on, for example, a scenario description or information inferred from a scenario (e.g., “a location suitable where a doctor would talk with a patient”). According to some embodiments, the immersive virtual scenario tool dynamically refines the request prompt via interactions with the user. At S230, the request prompt is transmitted to an agent manager AI model, such as a generative AI LLM. In some embodiments, the generative artificial intelligence model is “multimodal.” As used herein, the term “multimodal” may refer to a type of deep learning using a combination of various modalities of data (such as text, audio, or images) to create a robust model of real-world phenomena. As used herein, the phrase “generative AI” may refer to models that are capable of generating text, images, videos, or other data by learning patterns and structure of input training data and then creating new data that has similar characteristics. In some embodiments, the multimodal generative AI model might comprise a computational model able to achieve general-purpose language generation and other Natural Language Processing (“NLP”) tasks such as with an LLM.

At S240, an immersive virtual scenario tool may facilitate iterative interactions between the agent manager AI model and a plurality of autonomous agent expert AI models to automatically create a series of scenario chapters based on the immersive virtual scenario user description. In some embodiments, the user may be involved in the iterative refinement process. According to some embodiments, each AI model comprises an LLM. Moreover, in some embodiments, the three-dimensional scenario is associated with training for the user that is customized based on a user preference improvement goal. In this case, the plurality of autonomous agent expert AI models might include, for example, an educator expert AI model, a psychologist expert AI model, a domain expert AI model, a training evaluation expert AI model, etc. Other embodiments may be directed to entertainment for the user that is personalized based on individual user preferences. In this case, the plurality of autonomous agent expert AI models might include an experience researcher expert AI model, a creative director expert AI model, a content strategist expert AI model, a lead storyteller expert AI model, a quality assurance expert AI model, a legal/compliance expert AI model, an accessibility expert AI model, etc.

At S250, the system may store information about the three-dimensional scenario chapters in an immersive virtual scenario data store. At S260, it may be arranged for a user to interact with the three-dimensional scenario using a substantially real-time experience interaction engine such as the UNREAL ENGINE®. The immersive virtual scenario tool may be, according to some embodiments associated with a training use case, an educational use case, a public speaking use case, a sales simulation use case, an entertainment use case, etc. The information about the three-dimensional scenario in the immersive virtual scenario data store might be sharable with a plurality of users. Similarly, the information about the three-dimensional scenario in the immersive virtual scenario data store might be sharable with a plurality of users.

In this way, embodiments may help create immersive virtual environments that can be used for various scenarios such as training and simulation. Existing methods for creating these environments may not be sufficiently immersive to facilitate effective learning and recall, or to provide a realistic context for training or simulation. Moreover, the system may allow for the automated and repeatable creation of these environments, tailored according to the specific requirements of the scenario at hand. Note that existing solutions may be overly generic, not customizable, or inefficient in terms of the time and resources required for creation. Embodiments may leverage multiple generative AI models to create immersive, customizable, and shareable virtual environments.

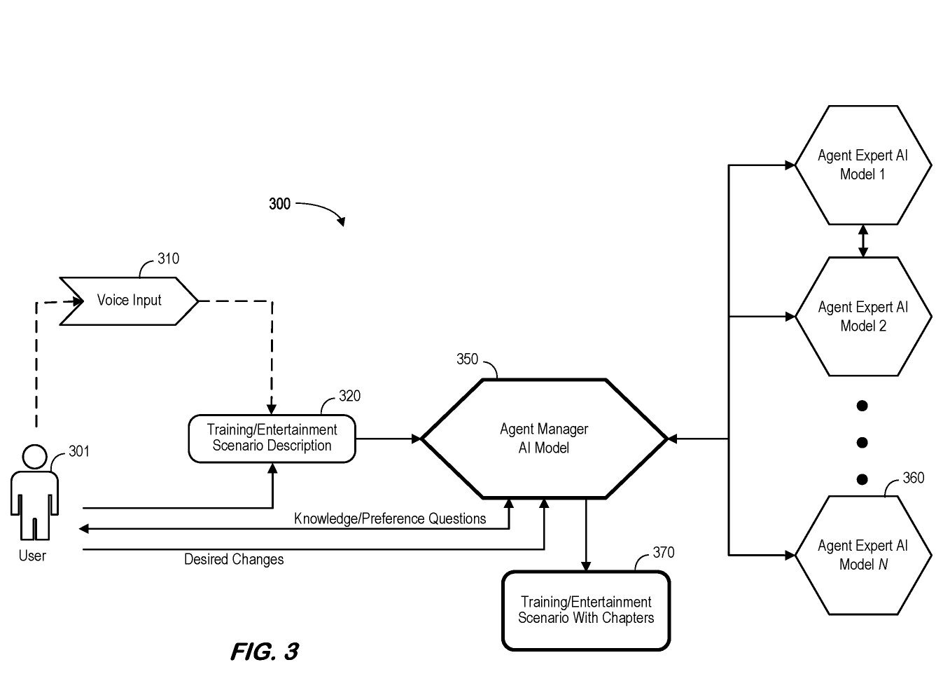

FIG. 3 is an overall workflow 300 that might be associated with training or entertainment in accordance with some embodiments. A user 301 may provide a scenario description and preferences 320 (e.g., “a modern doctor’s office with an X-ray machine,” “a tropical forest,” or “a medium size classroom”). In some embodiments, the scenario description and preferences 320 may be provided via a voice input 310. The scenario description and preferences 320 and a scenario generation prompt may then be modified by the user 301 if appropriate. When the prompt is complete and correct, it may be transmitted to a chat manager or agent manager AI model 350 to create an immersive virtual environment. In this way, embodiments may begin with the optimization of a specific prompt using prompt engineering (e.g., to structure an instruction that can be interpreted and understood by a generative artificial intelligence model). The prompt may be dynamic and based on user input (text or voice), which can include scenario descriptions, style hints, and additional wishes.

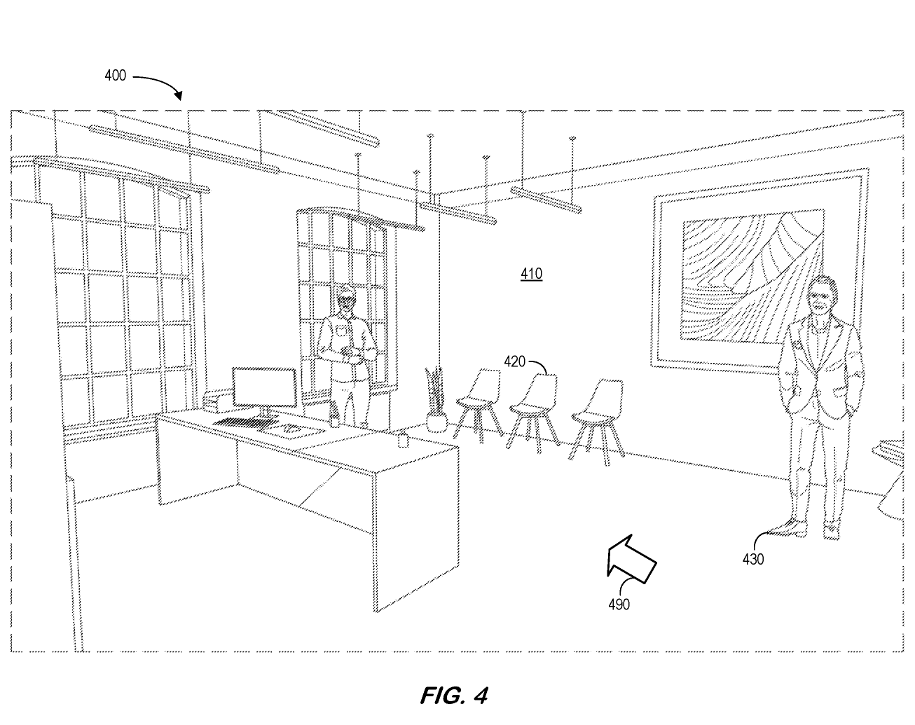

The agent manager AI model 350 interacts with multiple agent expert AI models 360 (expert models 1 through N). In particular, the agent manager AI model 350 may initiate iterative interactions with the plurality of autonomous agent expert AI models 360 to automatically create a series of scenario chapters 370 based on the immersive virtual scenario user description. For example, FIG. 4 is an immersive environment 400 in accordance with some embodiments. The environment 400 might include a three-dimensional room 410 with furniture 420 and virtual agents or characters 430 that a user can interact with (e.g., via voice, eye movement, a touchscreen or computer mouse pointer 490, etc.).

For effective learning and performance enhancement, complex scenarios may be segmented into smaller, more manageable sub-processes. This segmentation may allow for targeted identification and improvement of a user’s weak spots. However, the process of breaking down these scenarios into smaller parts is labor-intensive and demands a deep understanding of the trainee’s knowledge, cognitive process, domain, and pedagogic principles. This can make it challenging to customize the training process to the individual needs of each trainee, further complicating the training process.

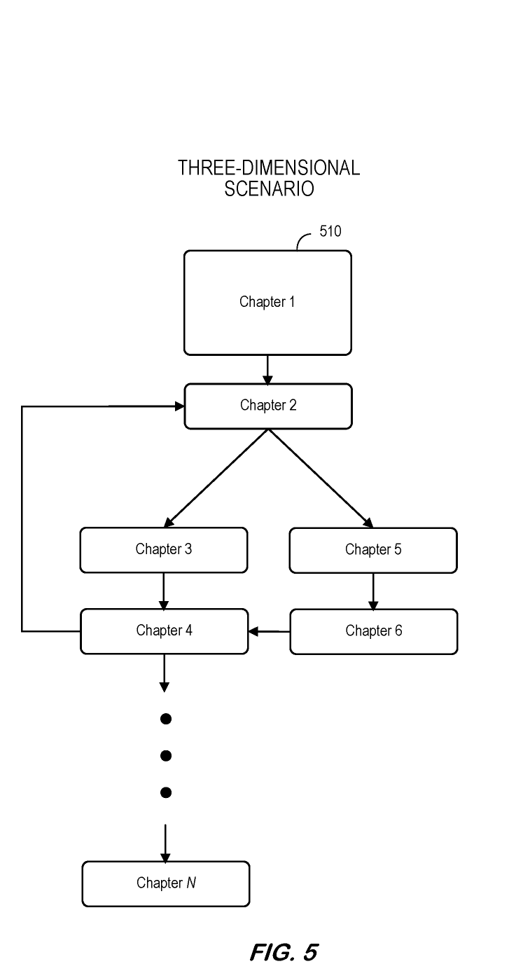

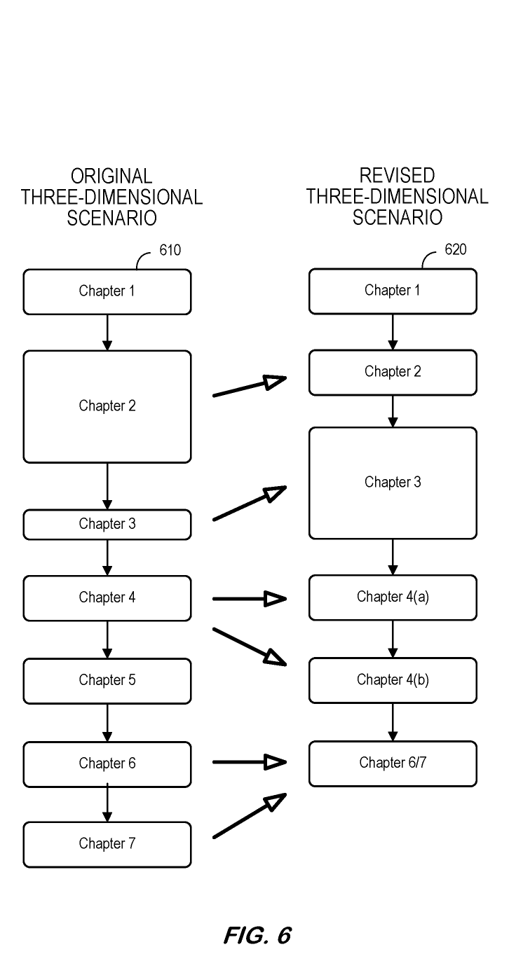

According to some embodiments, an immersive virtual scenario is arranged as a series of scenario chapters. For example, FIG. 5 shows three-dimensional scenario chapters 510 (chapters 1 through N) according to some embodiments. Note that some chapters 510 may be of different durations or contain different amounts of content as compared to other chapters (e.g., chapter 1 may be longer than chapter 2). Moreover, the scenario may split may have multiple branches (e.g., chapter 2 might split into either chapter 2 or chapter 5 depending on user behavior or chapters 3 and 6 might merge back into chapter 4). In addition, portions of a scenario might be repeated or skipped (e.g., chapter 4 might lead back to chapter 2 if the user does not understand the training material). In some embodiments, the system may modify chapters within a scenario. For example, FIG. 6 shows revisions 620 to original three-dimensional scenario chapters 610 in accordance with some embodiments. Note that chapters might be shortened or lengthened (e.g., chapter 2 has been shortened and chapter 3 has been lengthened). Similarly, chapters might be split (e.g., chapter 4 has been split into chapters 4(a) and 4(b)) or merged (e.g., chapters 6 and 7 are now a single chapter “6/7”), rearranged, deleted, added, etc. Some embodiments may include varying difficulties in connection with an entire training scenario or specific chapters. For example, variations in a story, chapters, characters, locations, or interactions might be associated with different difficulties (e.g., a character could be harder to convince, a location may be less intuitive to navigate, interactions may become harder to perform, etc.). Note that chapters, while tailored to a specific learning goal, can still be generic and/or dynamic in nature. For example, specific requirements of knowledge or skill required to advance to a specific chapter may be defined or generated. During training, the skills of an individual may be assessed on-the-fly allowing the system to suggest skipping a chapter (or only showing relevant content to a particular trainee). In some embodiments, the tool generates requirements for training while the actual dynamic routing and/or presentation of chapters happens during the training process. In some embodiments, the requirement descriptions are generated by the tool.

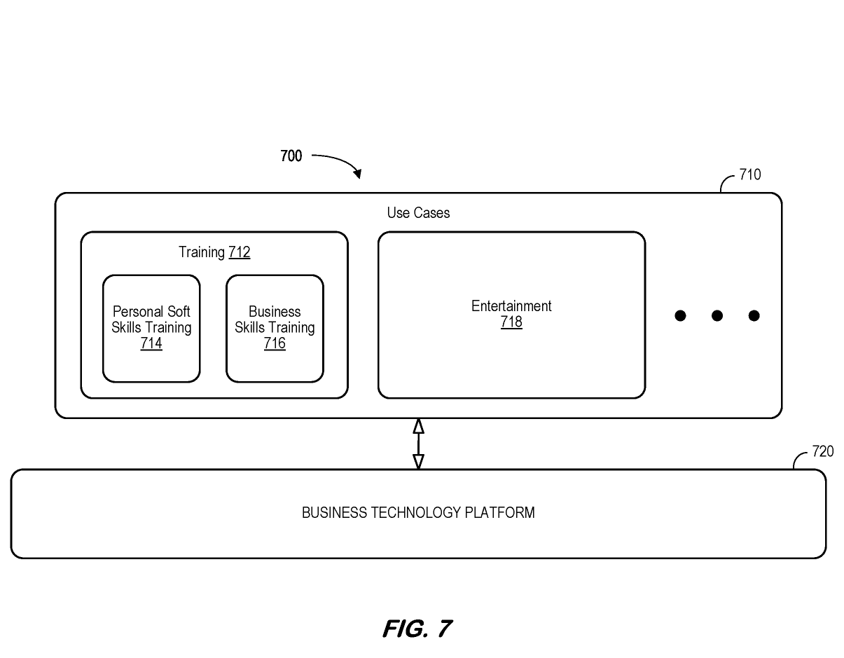

FIG. 7 is an illustration 700 of use case 710 examples according to some embodiments. The use cases 710 may interact with a business technology platform 720 to extend and personalize applications, integrate and connect landscapes, and/or unleash business users to connect processes and experiences, make decisions with confidence, and drive business innovation. The use cases 710 might be associated with, for example, training 712 and entertainment 718 (e.g., to create movies or video games), etc. The training 712 might include, for example, personal soft skills training 714 (e.g., becoming comfortable with public speaking, learning a new hobby, creating a video message for a special occasion, etc.) and/or business skills training 716 (e.g., sales simulation, learning programming, improving decision making, talking with employees, learning a new role, etc.). By way of examples only, other types of soft skill training might include social engineering training (e.g., for defensive or offensive educational purposes), providing feedback or mediation in connection with colleagues, superiors/subordinates, etc., introversion and/or social fear (e.g., simulating an initial job or team introduction), customer support to deal with upset customers, compliance, discrimination (e.g., anti-racism training), salary negotiations, etc.

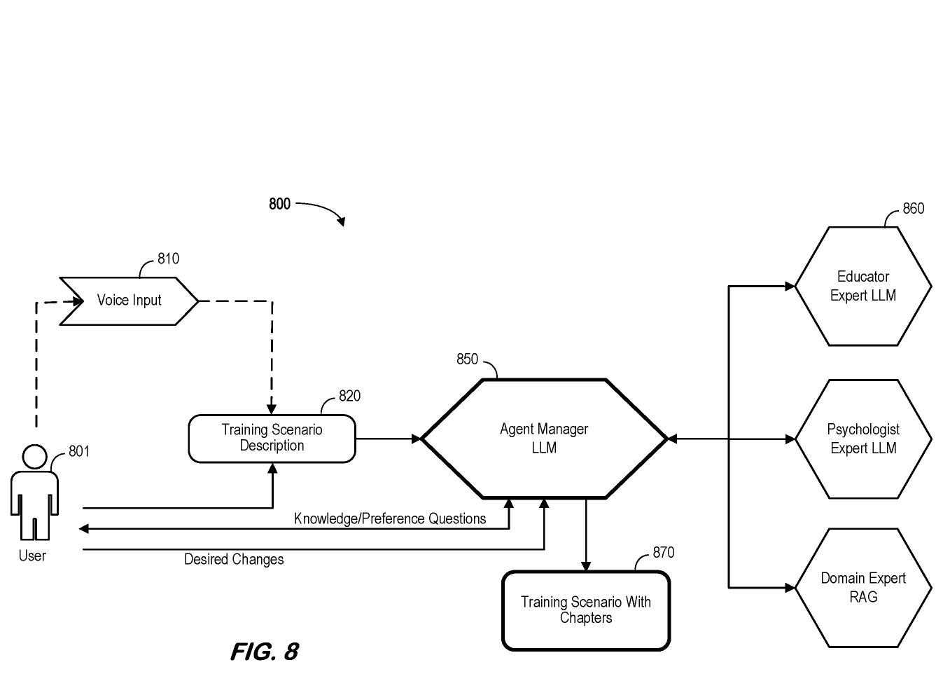

The training of complex scenarios, such as job interviews or medical procedures, may necessitate the mastery of specific skills or sequences of tasks. Traditional training methods often involve addressing these complex scenarios in a single run, which can lead to decreased learning rates. This is primarily due to the increasing difficulty in identifying problems or weak spots as the complexity of the scenario escalates. FIG. 8 is a training scenario workflow 800 in accordance with some embodiments. A user 801 may provide a training scenario description and preferences 820. In some embodiments, the training scenario description and preferences 820 may be provided via a voice input 810. The training scenario description and preferences 820 and a scenario generation prompt may then be modified by the user 801 if appropriate. When the prompt is complete and correct, it may be transmitted to a chat manager or agent manager LLM 850 to create an immersive virtual environment. The agent manager LLM 850 interacts with multiple agent expert LLMs 860 (e.g., an educator, a psychologist, a domain expert Retrieval-Augmented Generation (“RAG”) agent, etc.). In particular, the agent manager LLM 850 may initiate iterative interactions with the plurality of autonomous agent expert LLMs 860 to automatically create a series of training scenario chapters 870 based on the immersive virtual training scenario user description.

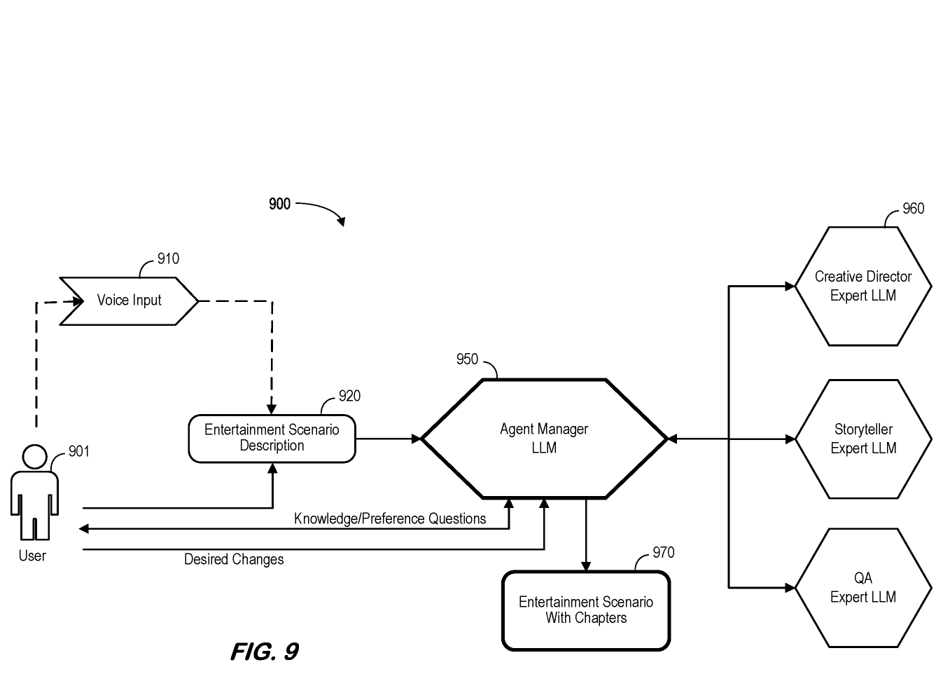

In addition to the training context, problems may extend to the realm of entertainment story generation. Here, the focus may shift from knowledge acquisition to the creation of narratives that align with user preferences. The current methods of story generation often lack the ability to tailor content to individual user preferences, leading to less engaging and personalized experiences. FIG. 9 is an entertainment scenario workflow 900 according to some embodiments. As before, a user 901 may provide an entertainment scenario description and preferences 920. In some embodiments, the entertainment scenario description and preferences 920 may be provided via a voice input 910. The entertainment scenario description and preferences 920 and a scenario generation prompt may then be modified by the user 901 if appropriate. When the prompt is complete and correct, it may be transmitted to a chat manager or agent manager LLM 950 to create an immersive virtual environment. The agent manager LLM 950 interacts with multiple agent expert LLMs 960 (e.g., a creative director, a storyteller, and QA experts). In particular, the agent manager LLM 950 may initiate iterative interactions with the plurality of autonomous agent expert LLMs 960 to automatically create a series of entertainment scenario chapters 970 based on the immersive virtual entertainment scenario user description.

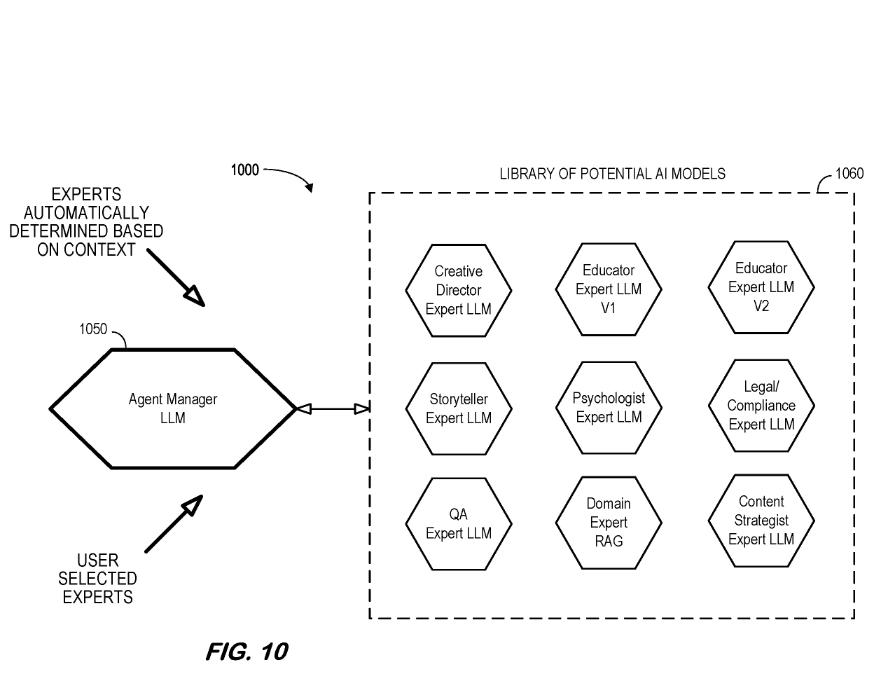

Thus, agent managers may consult with a set of multiple expert AI models, and the specific set of autonomous agent experts might vary. FIG. 10 is an example 1000 of how a set of agent experts might be constructed in accordance with some embodiments. In this embodiment, an agent manager LLM 1050 may access a library of potential AI models 1060. The library of potential AI models 1060 might include, for example, a set of previously created LLMs (including multiple versions of certain types of LLM). For training story generation, an exemplary set of agents might include a chat manager, an educator, a psychologist or pedagogue, a domain expert, and a user (human). Each agent may play a unique role in the process. The chat manager may facilitate the interaction between the other agents, while the educator, psychologist, and domain expert work collaboratively to create, review, and refine the training chapters. For example, the process might begin with a user describing a scenario. The educator then uses this information to create suggestions for training chapters. These suggestions are then reviewed by the psychologist and domain expert, who provide their feedback and approval. The user may be involved throughout the process, particularly when another agent needs to better understand the user’s knowledge base and/or preferences. This involvement may help ensure that the training chapters are tailored to the user’s individual needs, learning style, and preferences. Finally, the generated story can be refined using subsequent prompts in a chat-like manner to address specific details. In some embodiments, the agents may interact with each other (e.g., iteratively in a group chat manner) when creating a story or scenario chapter.

For entertainment scenarios, the set of agents in the library of potential AI models 1060 might include, for example, a user experience researcher that asks the right questions to gain a detailed understanding of user preferences. Other agents might include: a creative director to provide overall vision and/or direction coordination; a content strategist approach for specific content in when combining user preferences, overall vision, market trends; a lead writer and storyteller to craft plotlines, create characters, and write dialogue; a quality assurance tester to utilize the scenario and provide constructive criticism; etc.

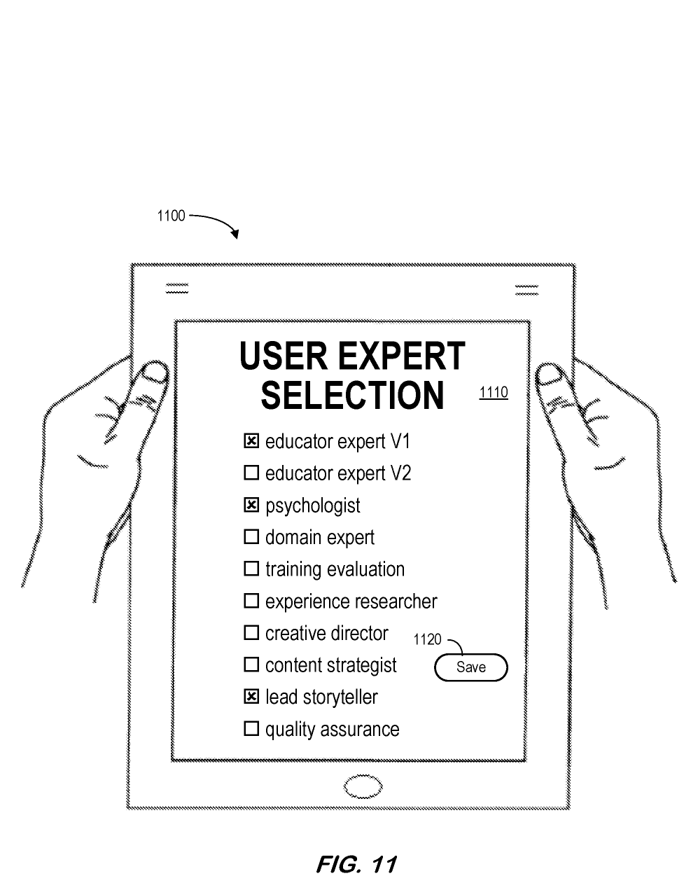

The agent manager LLM 1050 might select agents based on context information (e.g., certain sets of training or entertainment agents might be pre-packaged for specific types of scenarios and/or user input. For example, FIG. 11 illustrates a tablet computer 1100 providing a user expert selection display 1110 according to some embodiments. The user expert selection display 1110 might be used, for example, to let an employee select which agents should help with creating a scenario to provide instruction about new safety guidelines being implemented by an enterprise. A user may interact with the display 1110, such as by selecting or deselecting various checkboxes and/or activating a “Save” icon 1120 when finished.

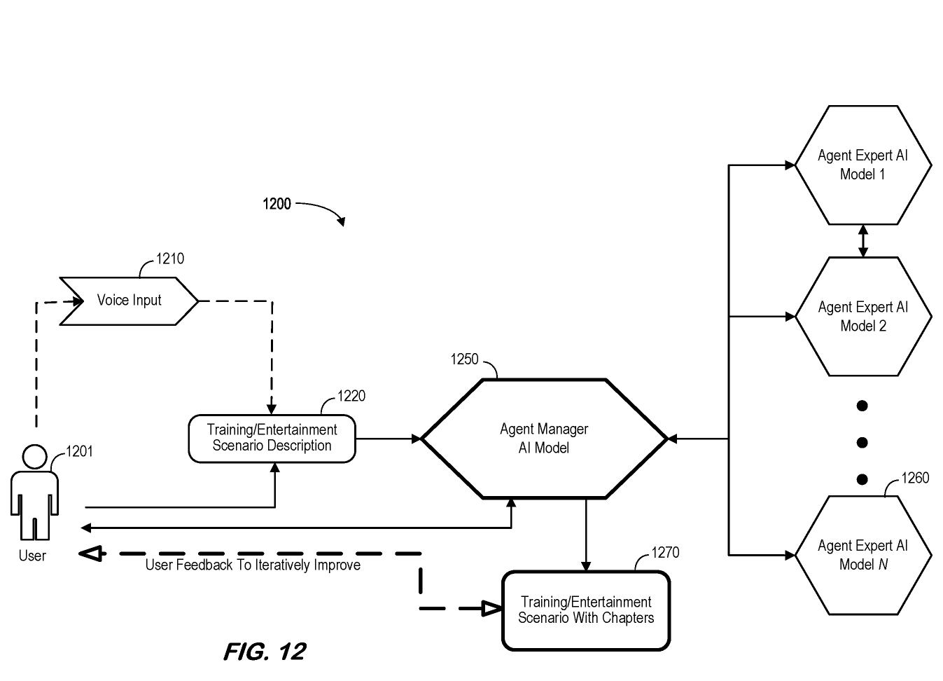

Some embodiments described herein may facilitate continuous feedback and improvement, and the autonomous agents can adjust the scenario content and chapters based on the user’s progress and feedback. FIG. 12 is a scenario workflow 1200 incorporating feedback in accordance with some embodiments. As before, a user 1201 may provide a training or entertainment scenario description and preferences 1220. In some embodiments, the scenario description and preferences 1220 may be provided via a voice input 1210. The scenario description and preferences 1220 and a scenario generation prompt may then be modified by the user 1201 if appropriate. When the prompt is complete and correct, it may be transmitted to a chat manager or agent manager AI model 1250 to create an immersive virtual environment. The agent manager AI model 1250 interacts with multiple agent expert AI models 1260. In particular, the agent manager LLM 1250 may initiate iterative interactions with the plurality of autonomous agent expert AI models 1260 to automatically create a series of training or entertainment scenario chapters 1270 based on the immersive virtual scenario user description. Moreover, the user 1201 may provide feedback to continuously improve the scenario and/or the performance of various AI models.

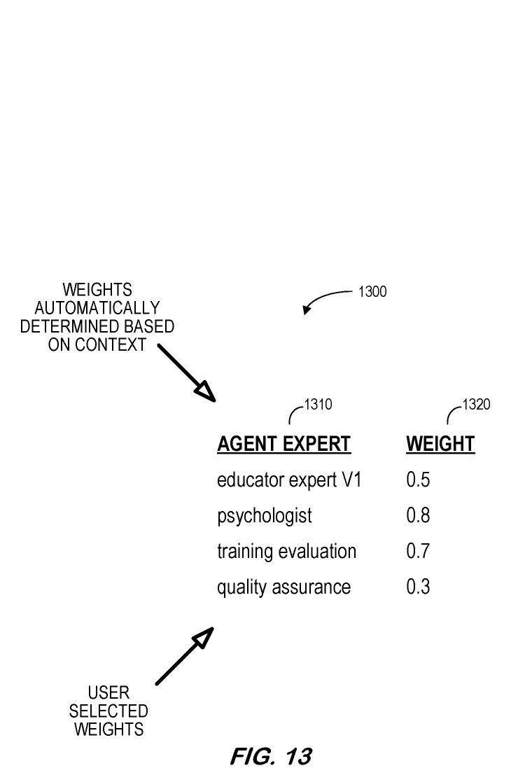

In some cases, an agent manager may receive conflicting information from different AI models. In this case, individual weights assigned to each AI model may be used to help resolve the problem. FIG. 13 is an example 1300 of agent expert weights according to some embodiments. For each agent expert 1310 a weight 1320 is assigned (with 0.0 being the lowest and 1.0 being the highest). In this example, the opinion of the psychologist being overruled if the training evaluation expert and quality assurance expert disagree (because 0.8 is a lower weight as compared to 0.7 + 0.3). The set of weights might be automatically determined, for example, based on context according to some embodiments. For example, one training situation might be associated with a pre-packaged set of weights while a different training situation is associated with a different set. In other embodiments, the weights might be manually set by a user.

Instead of, or in addition to, assigning individual weights to each AI model, some embodiments may have the AI models interact with each other to resolve conflicts between them (e.g., in a group chat manner). The LLMs might, for example, interact with each other independently (e.g., in a multi-turn fashion during a single iteration) allowing for further discussions between the models. Some embodiments may utilize an additional conflict resolution LLM to act a mediator for the LLMs (e.g., leading a discussion based on the appropriate weights). In other embodiments, an unbiased mediator may return discussion results after several turns and the agent manager may determine a result based on the appropriate weights).

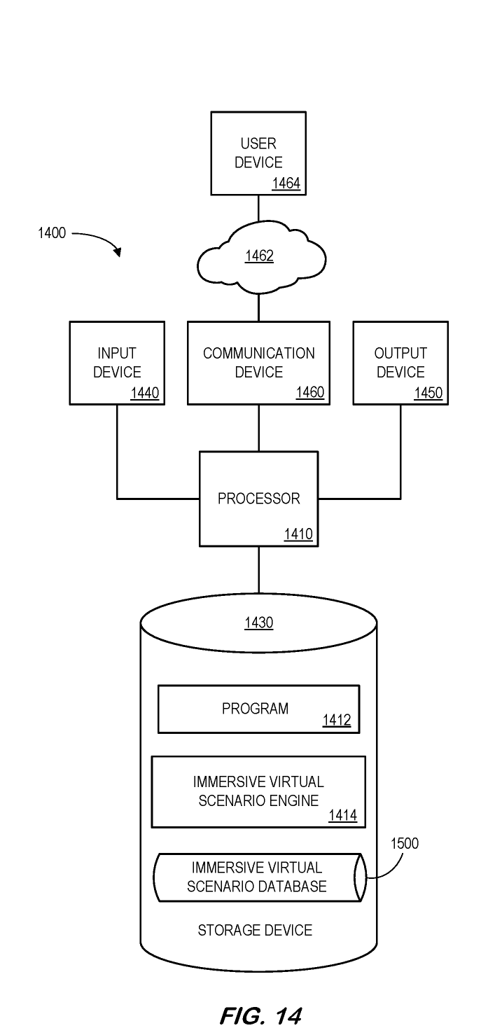

Note that the embodiments described herein may be implemented using any number of different hardware configurations. For example, FIG. 14 is a block diagram of an apparatus or platform 1400 that may be, for example, associated with the framework 100 of FIG. 1 (and/or any other system described herein). The platform 1400 comprises a processor 1410, such as one or more commercially available Central Processing Units (“CPUs”) in the form of one-chip microprocessors, coupled to a communication device 1460 configured to communicate via a communication network 1462. The communication device 1460 may be used to communicate, for example, with one or more user devices 1464 via a distributed computer network 1462. The platform 1400 further includes an input device 1440 (e.g., a computer mouse and/or keyboard to input scenario information, feedback, etc.) and/an output device 1450 (e.g., a computer monitor to render a display, transmit recommendations, charts, alerts, and/or reports about immersive virtual scenarios, etc.).

The processor 1410 also communicates with a storage device 1430. The storage device 1430 may comprise any appropriate information storage device, including combinations of magnetic storage devices (e.g., a hard disk drive), optical storage devices, mobile telephones, and/or semiconductor memory devices. The storage device 1430 stores a program 1412 and/or immersive virtual scenario engine 1414 for controlling the processor 1410. The processor 1410 performs instructions of the programs 1412, 1414, and thereby operates in accordance with any of the embodiments described herein. For example, the processor 1410 may receive, from a user, an immersive virtual scenario user description. A request prompt may then be automatically created by the processor 1410 (based on the scenario user description) and transmitted to an agent manager AI model. The agent manager AI model facilitates iterative interactions between the agent manager AI model and a plurality of autonomous agent expert AI models to automatically create a series of scenario chapters based on the immersive virtual scenario user description. The processor 1410 can then store information about the series of scenario chapters in an immersive virtual scenario database 1500 and the user can interact with the scenario using a substantially real-time experience interaction engine.

The programs 1412, 1414 may be stored in a compressed, uncompiled and/or encrypted format. The programs 1412, 1414 may furthermore include other program elements, such as an operating system, clipboard application, a database management system, and/or device drivers used by the processor 1410 to interface with peripheral devices.

As used herein, information may be “received” by or “transmitted” to, for example: (i) the platform 1400 from another device; or (ii) a software application or module within the platform 1400 from another software application, module, or any other source.

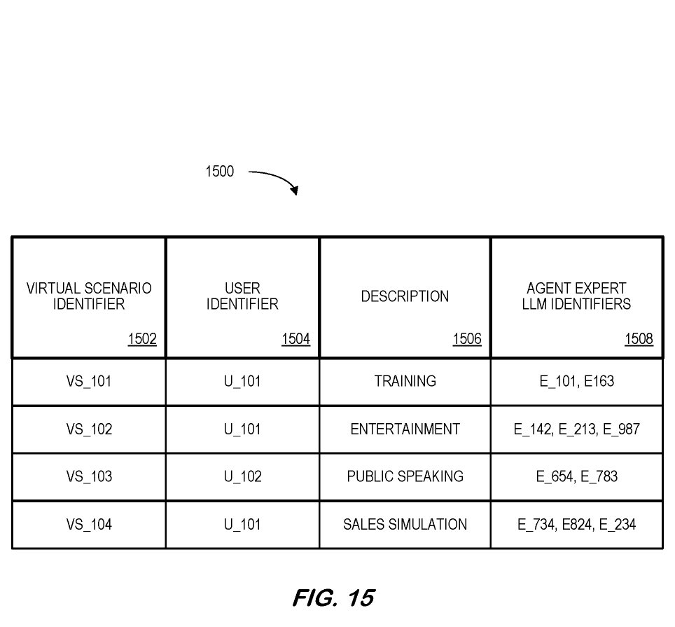

In some embodiments (such as the one shown in FIG. 14), the storage device 1430 further stores the immersive virtual scenario database 1500. An example of a database that may be used in connection with the platform 1400 will now be described in detail with respect to FIG. 15. Note that the database described herein is only one example, and additional and/or different information may be stored therein. Moreover, various databases might be split or combined in accordance with any of the embodiments described herein.

Referring to FIG. 15, a table is shown that represents the immersive virtual scenario database 1500 that may be stored at the platform 1400 according to some embodiments. The table may include, for example, entries identifying scenarios that may be experienced. The table may also define fields 1502, 1504, 1506, 1508 for each of the entries. The fields 1502, 1504, 1506, 1508 may, according to some embodiments, specify: a virtual scenario identifier 1502, a user identifier 1504, a description 1506, and agent expert LLM identifiers 1508. The immersive virtual scenario database 1500 may be created and updated, for example, when a user generates a new scenario request, adjusts an existing scenario, provides feedback, etc.

The virtual scenario identifier 1502 might be a unique alphanumeric label that is associated with an interactive, immersive experience. The user identifier 1504 may show who requested the scenario. The description 1506 might indicate that the scenario is associated with training, education, public speaking, etc. The agent expert LLM identifiers 1508 may comprise a list of the expert agents that were used to construct the immersive experience, associated weights, etc.

In this way, embodiments may be dynamic and adaptable (unlike prior solutions that are often hard-coded and inflexible). Generative AI models may be leveraged to create environments based on user-specific prompts, allowing for the generation of virtual spaces that are tailored to a user’s specific needs and the situation at hand. This adaptability enhances the relevance and usability of the generated environments, providing a more personalized and immersive experience. Embodiments may also improve efficiency in the creation of virtual environments. Traditional methods can be time-consuming and resource-intensive, requiring significant manual effort to design and implement. In contrast, embodiments may automate the process and significantly reduce the time and resources required to create high-quality, immersive environments.

Embodiments may leverage the capabilities of a LLM (LLM) and an agent-based system to create a flexible and adaptive training process or entertainment story. This process is tailored to individual user needs, knowledge base, learning style, and preferences, thereby offering a personalized learning experience. This may represent a substantial improvement over traditional methods, which often use a one-size-fits-all approach and may not cater to the unique needs of each user.

The normal process of creating training plans and stories can be costly and labor-intensive, requiring the input and approval of multiple experts. The invention streamlines this process by delegating these tasks to autonomous agents, thereby reducing labor costs and increasing efficiency. The agents work collaboratively to create, review, and refine the chapters, ensuring that the training process/story is effective/pleasurable. Moreover, embodiments may break down complex scenarios into distinct, manageable training chapters that build upon one another. Such an approach may let the user make bridges to existing knowledge (thereby improving learning and recall). This may be a significant advantage over traditional training methods, which often tackle complex scenarios in a single run and may not facilitate effective learning and recall. Combined with autonomous location and character generation, embodiments may define a new paradigm of highly tailored content generation.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with some embodiments of the present invention (e.g., some of the information associated with the databases described herein may be combined or stored in external systems). Moreover, although some embodiments are focused on particular types of use cases, any of the embodiments described herein could be applied to other types of use cases.

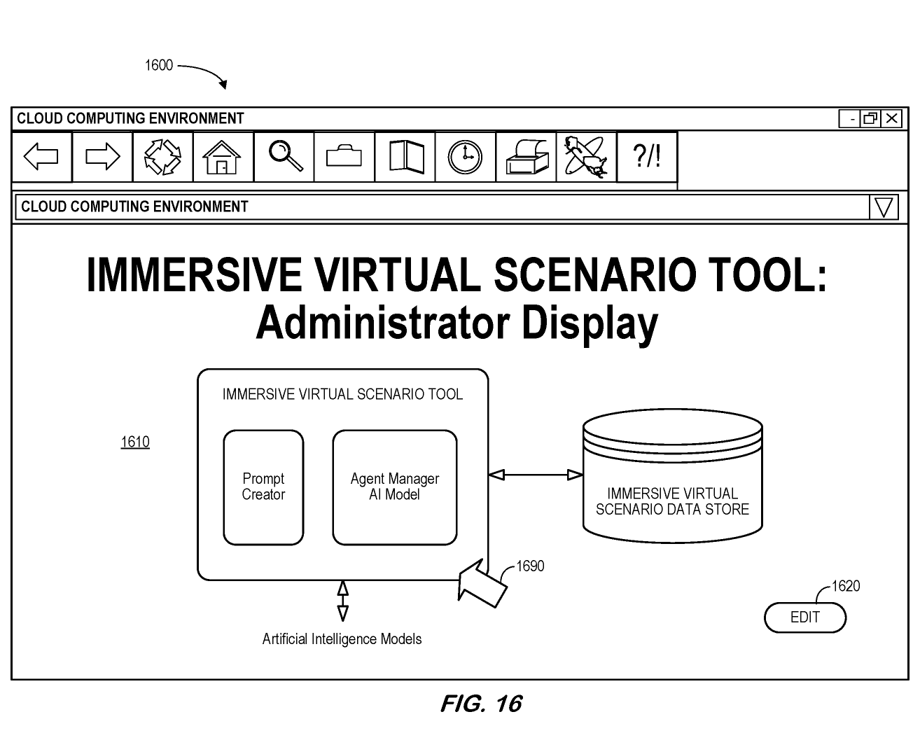

In addition, the displays shown herein are provided only as examples, and any other type of user interface could be implemented. FIG. 16 is an operator or administrator display in accordance with some embodiments. The display 1600 includes a graphical representation 1610 of an immersive virtual scenario tool in accordance with any of the embodiments described herein. Selection of an element on the display 1600 (e.g., via a touchscreen or computer pointer 1690) may result in display of a pop-up window containing more detailed information about that element and/or various options (e.g., to define how an immersive virtual scenario tool interacts with an immersive experience framework, etc.). Selection of an “Edit” icon 1620 may also let an operator or administrator adjust the operation of the system (e.g., to change mapping to a data store, adjust available expert agents, make changes to a virtual scenario, etc.).

The present invention has been described in terms of several embodiments solely for the purpose of illustration. Persons skilled in the art will recognize from this description that the invention is not limited to the embodiments described but may be practiced with modifications and alterations limited only by the spirit and scope of the appended claims.

1. A system associated with an immersive experience framework, comprising:
an immersive virtual scenario data store that contains information about a plurality of three-dimensional scenarios, each three-dimensional scenario being associated with a series of scenario chapters; and
an immersive virtual scenario tool, coupled to the immersive virtual scenario data store, including:
a computer processor, and
a computer memory storing instructions that when executed by the computer processor cause the immersive virtual scenario tool to:
receive, from a user, an immersive virtual scenario user description,
create a scenario prompt based on the immersive virtual scenario user description,
transmit the scenario prompt to an agent manager Artificial Intelligence (“AI”) model,
facilitate iterative interactions between the agent manager AI model and a plurality of autonomous agent expert AI models to automatically create a series of scenario chapters based on the immersive virtual scenario user description,
store information about the series of scenario chapters in the immersive virtual scenario data store, and
arrange for the user to interact with the three-dimensional scenario using a substantially real-time experience interaction engine.

2. The system of claim 1, wherein each AI model comprises a Large Language Model (“LLM”).

3. The system of claim 1, wherein the three-dimensional scenario is associated with training for the user that is customized based on a user preference improvement goal and the plurality of autonomous agent expert AI models include at least two of: (i) an educator expert AI model, (ii) a psychologist expert AI model, (iii) a domain expert AI model, and (iv) a training evaluation expert AI model.

4. The system of claim 1, wherein the three-dimensional scenario is associated with entertainment for the user that is personalized based on individual user preferences and the plurality of autonomous agent expert AI models include at least two of: (i) an experience researcher expert AI model, (ii) a creative director expert AI model, (iii) a content strategist expert AI model, (iv) a lead storyteller expert AI model, (v) a quality assurance expert AI model, (vi) a legal/compliance expert AI model, (vii) an accessibility expert AI model, and (viii) any other appropriate agent expert AI model.

5. The system of claim 1, wherein the agent manager AI model is further to automatically select the plurality of agent expert AI models from a library of potential expert AI models.

6. The system of claim 1, wherein the plurality of agent expert AI models are manually selected by the user from a library of potential expert AI models.

7. The system of claim 1, wherein an automatically generated potential series of scenario chapters undergo human review before being stored in the immersive virtual scenario data store.

8. The system of claim 1, wherein the immersive virtual scenario tool receives user feedback to iteratively improve the agent AI models or the series of scenario chapters.

9. The system of claim 8, wherein an improvement to a three-dimensional scenario chapter includes dividing or combining chapters.

10. The system of claim 1, wherein the agent manager AI model is further to assign different weights for different agent expert AI models.

11. The system of claim 1, wherein the autonomous agent expert AI models interact with each other when automatically creating the series of scenario chapters.

12. The system of claim 1, wherein a request prompt is based on at least one of: (i) a scenario description of a virtual location, and (ii) information inferred from a scenario.

13. The system of claim 1, wherein the immersive virtual scenario user description further includes information about at least one of: (i) a room description, (ii) a physics description, (iii) a style suggestion, (iv) a user goal, and (v) a character in a virtual location.

14. The system of claim 1, wherein the immersive virtual scenario user description received from the user includes at least one of: (i) a text request, (ii) an audio request, (iii) an image request, and (iv) a video request.

15. The system of claim 1, wherein the information about the three-dimensional scenario in the immersive virtual scenario data store is sharable with a plurality of users or a plurality of creators.

16. A computer-implemented method associated with an immersive experience framework, comprising:
receiving, by a computer processor from a user, an immersive virtual scenario user description;
creating a scenario prompt based on the immersive virtual scenario user description;
transmitting the scenario prompt to an agent manager Large Language Model (“LLM”);
facilitating iterative interactions between the agent manager LLM and a plurality of autonomous agent expert LLMs to automatically create a series of scenario chapters based on the immersive virtual scenario user description;
storing information about the series of scenario chapters in an immersive virtual scenario data store; and
arranging for the user to interact with a three-dimensional scenario using a substantially real-time experience interaction engine.

17. The method of claim 16, wherein the three-dimensional scenario is associated with training for the user that is customized based on a user preference improvement goal and the plurality of autonomous agent expert LLMs include at least two of: (i) an educator expert LLM, (ii) a psychologist expert LLM, (iii) a domain expert LLM, (iv) a training evaluation expert LLM, and (v) any other appropriate agent expert LLM.

18. The method of claim 16, wherein the three-dimensional scenario is associated with entertainment for the user that is personalized based on individual user preferences and the plurality of autonomous agent expert LLMs include at least two of: (i) an experience researcher expert LLM, (ii) a creative director expert LLM, (iii) a content strategist expert LLM, (iv) a lead storyteller expert LLM, (v) a quality assurance expert LLM, (vi) a legal/compliance expert LLM, (vii) an accessibility expert LLM, and (viii) any other appropriate agent expert LLM.

19. One or more non-transitory computer-readable media storing computer-executable instructions that, when executed by a computing system, cause the computing system to perform operations comprising:
receiving, by a computer processor from a user, an immersive virtual scenario user description;
creating a scenario prompt based on the immersive virtual scenario user description;
transmitting the scenario prompt to an agent manager Artificial Intelligence (“AI”) model;
selecting a plurality of autonomous agent expert AI models from a library of potential expert AI models;
facilitating iterative interactions between the agent manager AI model and the plurality of agent expert AI models to automatically create a series of scenario chapters based on the immersive virtual scenario user description;
storing information about the series of scenario chapters in an immersive virtual scenario data store; and
arranging for the user to interact with a three-dimensional scenario using a substantially real-time experience interaction engine.

20. The media of claim 19, wherein the agent manager AI model is further to automatically select the plurality of agent expert AI models from a library of potential expert AI models.

21. The media of claim 19, wherein the plurality of agent expert AI models are manually selected by the user from a library of potential expert AI models.
